(19) United States
(12) Patent Application Publication
(10) Pub. No.: US 2010/0213038 A1
(43) Pub. Date: Aug. 26, 2010

(54) IMAGE PUSH-BUTTON ASSEMBLY STRUCTURE

(76) Inventor: Jen-Wen Sun, Sindian City (TW)

Correspondence Address: Muncy, Geissler, Olds & Lowe, PLLC, 4000 Legato Road, Suite 310, FAIRFAX, VA, 22033, US

(21) Appl. No.: 12/390,865

(22) Filed: Feb. 23, 2009

(51) Int. Cl. H01H 3/16

(52) U.S. Cl. 200/61.1

(57) ABSTRACT

An image push-button assembly structure is a push-button set which includes a push-button device and a display screen. The push-button device is formed with a sealed space, a pre-determined position on a surface of the push-button device is provided with at least one push-button element, an interior of the sealed space is provided with the display screen which is fixed on a display circuit board, the display circuit board is electrically connected with the push-button element, and a side of the push-button device is provided with a circuit board which is fixed on the push-button device. Therefore, as the push-button device is formed integrally for an entire structure, an assembly procedure can be simplified, an entire cost can be reduced and convenience in operation can be even improved.

### BACKGROUND OF THE INVENTION

a) Field of the Invention

The present invention relates to a push-button structure, and more particularly to an image push-button assembly structure which is provided with an image display function, is simple in structure and is convenient to operate.

b) Description of the Prior Art

To activate all kinds of mechanisms, a push-button structure has been already used very popularly, wherein as being simple in structure, a push switch is widely used now; for example, a light switch for turning on illuminating equipment, a power switch for turning on computer equipment or even a computer keyboard for input on the computer equipment is also the push switch.

A conventional push switch is usually constituted by a push-button unit and a push-button seat. The push-button unit is provided with a push part to be pressed down by a user, the push-button seat holds that push-button unit and a bottom of the push-button seat is provided with a separated metal junction. After the user has pressed down the push switch, the metal junction will be connected electrically, so as to accomplish conducting electricity. On the other hand, an elastic element (for example, a spring) is usually provided between the push-button seat and the push-button unit, such that after the user has pressed down the push-button unit, the push-button unit can be bounced back to an original position by the elastic element.

This kind of push-button is only provided with a function of conducting electricity by pressing; whereas, some related vendors have developed a kind of light button in which the push-button unit is light permeable. Therefore, when the push-button is pressed down (ON), the light switch will illuminate, while if the push-button is not pressed down (OFF), the light switch will not illuminate, thereby achieving a function of prompting.

However, when the aforementioned push switches are used, following issues and shortcomings actually exist to be improved.

The conventional light switch can only display light and none of the existing push-buttons is provided with the switch. In addition, the push-button is only usually provided with a function of conducting a circuit, so as to form a connection to equipment which needs to be turned on, and to enable the light to be further provided with a humanized prompting function.

Accordingly, how to solve the aforementioned issues and shortcomings of the prior art is to be studied and researched for improvement by the present inventor and related industries

### SUMMARY OF THE INVENTION

The primary object of the present invention is to provide an image push-button assembly structure which is a push-button set, wherein the push-button set is composed of a push-button device and a display screen. The push-button device is formed with a sealed space, a pre-determined position on a surface of the push-button device is provided with at least one push-button element, an interior of the sealed space is provided with the display screen which is fixed on a display circuit board, and the display circuit board is electrically connected with the push-button element. On the other hand, a side of the push-button device is provided with a circuit board which is fixed on the push-button device. Therefore, as the push-button device is formed integrally for an entire structure, an assembly procedure is simplified, an entire cost is reduced and convenience in operation is even improved.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of a preferred embodiment of the present invention.

FIG. 2 shows an exploded view of a preferred embodiment of the present.

FIG. 3 shows a schematic view of a usage state of the present invention in which a push-button element is pressed down to display an image.

FIG. 4 shows a schematic view of a usage state of the present invention in which a display screen is changed by using the push-button element again.

### DETAILED DESCRIPTION OF THE PREFERRED EMBODIMENTS

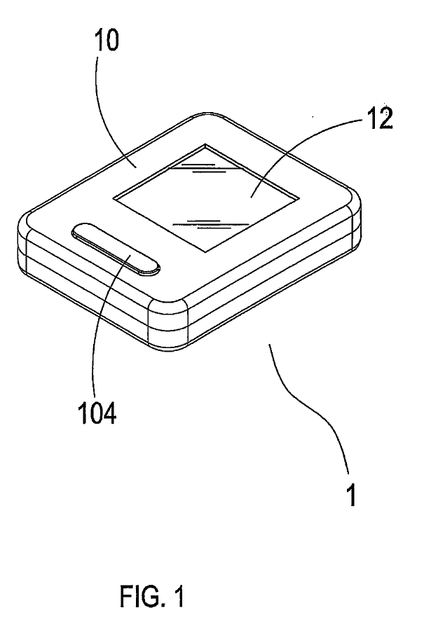

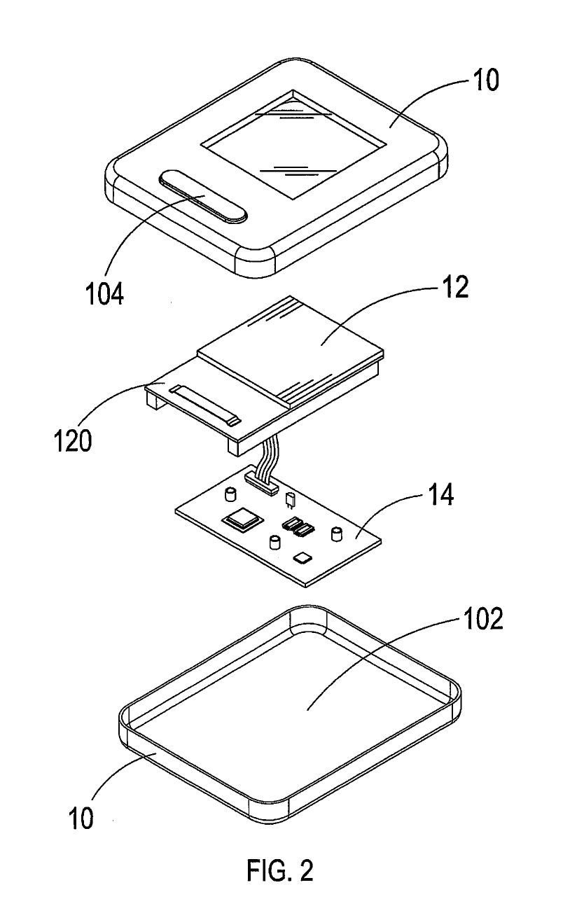

Referring to FIG. 1 and FIG. 2, it shows a three-dimensional view and an exploded view, of a preferred embodiment of the present invention which is an image push-button assembly structure. The structure is a push-button set 1 comprising a push-button device 10 and a display screen 12, wherein the push-button device 10 is formed with a sealed space 102, a pre-determined position on a surface of the push-button device 10 is provided with at least one push-button element 104, an interior of the sealed space 102 is provided with the display screen 12 which is fixed on a display circuit board 120 and the display circuit board 120 is electrically connected with the push-button element 104; whereas, a side of the push-button device 10 is provided with a circuit board 14 which is fixed on the push-button device 10.

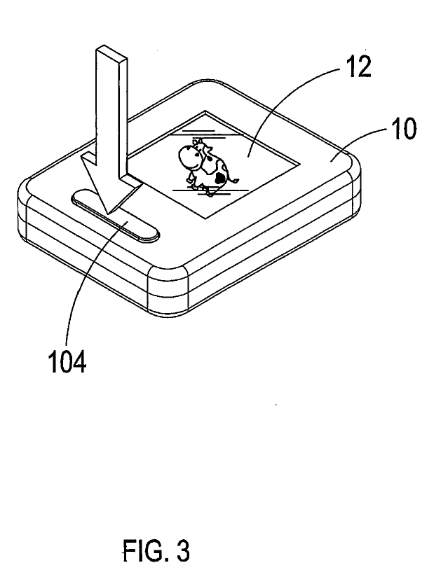

Referring to FIG. 3, it shows a schematic view of a usage state of the present invention in which the push-button element is pressed down to display an image. As shown in FIG. 3, along with FIG. 2, a user first presses down the push-button element 104 on the push-button device 10. At this time, the display circuit board 120 will be electrically connected with the push-button element 104, and in a mean time, produce an electricity loop with the circuit board 14 and transmit a signal through a signal line (not shown on the drawings) from the circuit board 14 to the display circuit board 120, allowing the user to be clearly aware of related information through the display screen 12 and providing an easier and more convenient operation.

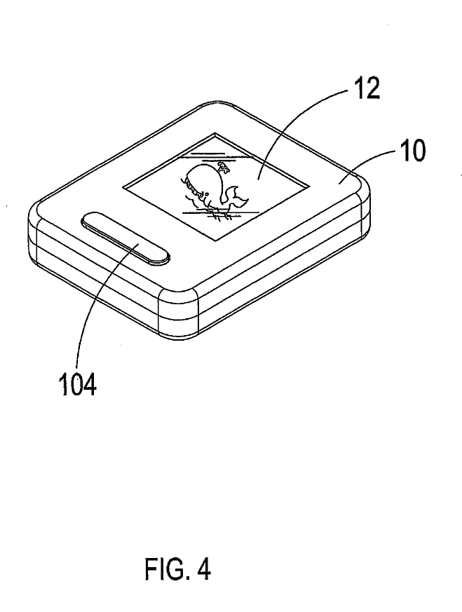

Referring to FIG. 4, it shows a schematic view of a usage state of the present invention in which the display screen is changed by using the push-button element again. When the user is to change to a different icon, he or she only needs to press down the push-button element 104 again, allowing the display circuit board 120 and the circuit board 14 in the push-button device 10 to be electrically connected once more that the information can be connected to the display circuit board 120 and displayed on the display screen 12 through the signal line again. If this image is not what the user requires, then the aforementioned operations can be conducted repeatedly until that the image that the user needs is displayed.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An image push-button assembly structure, being a push-button set comprising a push-button device which is formed with a sealed space, a pre-determined position on a surface of which is provided with at least one push-button element; and a display screen which is provided in the sealed space and is fixed on a display circuit board being electrically connected with the push-button element.

2. The image push-button assembly structure according to claim 1, wherein the display circuit board is electrically connected with a circuit board to form an electricity loop.
